(19) United States
(12) Patent Application Publication
(10) Pub. No.: US 2009/0216443 A1
(43) Pub. Date: Aug. 27, 2009

(54) SYSTEMS AND METHODS FOR NOTIFICATION OF LOCATION VIA AN ELECTRONIC DEVICE

(75) Inventor: Ying SHI, Nanjing City (CN)

Correspondence Address: PCE INDUSTRY, INC.;ATT. Steven Reiss, 458 E. LAMBERT ROAD, FULLERTON, CA, 92835, US

(73) Assignees: SHENZHEN FUTAIHONG PRECISION INDUSTRY CO., LTD., ShenZhen City (CN); Chi Mei Communication Systems, Inc., Tu-Cheng City (TW)

(21) Appl. No.: 12/257,403

(22) Filed: Oct. 24, 2008

(30) Foreign Application Priority Data
Feb. 27, 2008 (CN) 200810300409.X

(51) Int. Cl. G01C 21/36

(52) U.S. Cl. 701/211

(57) ABSTRACT

A method for notification of location via an electronic device. The method alerts a user of proximity to a desired location along a preset travel route, using Global Positioning System (GPS) technology. A related system is also provided.

### BACKGROUND

1. Field of the Invention

Embodiments of the disclosure are related to GPS positioning, and particularly to a system and method for notification of location via an electronic device.

2. Description of Related Art

Passengers utilizing public transportation may not be familiar with routes travelled, or a current location on the routes. Furthermore, public transportation announcement systems providing current stop or station information require constant attention from users in order to be aware of their progress.

Vehicular navigation devices commonly apply Global Positioning System (GPS) technology to provide geographic location information. The GPS uses a collection of between 24 and 32 Medium Earth Orbit (MEO) satellites that transmit precise microwave signals for enabling receivers to determine location, speed, direction, and time. In addition to GPS, some navigation devices makes use of Enhanced GPS (E-GPS) technology, providing universal positioning reliability not only indoors and in zero-GPS signal conditions, but at greatly increased speeds in poor GPS-reception areas where most electronic devices are used. Moreover, the E-GPS exploits data from the cellular communication network to speed GPS fixing. However, vehicular navigation systems with GPS or E-GPS capability only highlight travel routes and provide guidance by visible or audible means. A user or driver may be unfamiliar with the route, and thus miss arrival at a destination or other key location.

What is needed, therefore, is a system and method for notification of location via an electronic device.

### SUMMARY

A method for notification of location via an electronic device is provided. The method includes registering a travel route and a desired location using the electronic device, wherein the desired location is user-selected, identifying a location of the desired location from an electronic map stored in a memory system of the electronic device, setting a location notification distance and a notification mode, acquiring a current user location via a Global Positioning System (GPS) of the electronic device, determining a remaining distance between the current user location and the desired location according to the travel route, determining if the remaining distance equals location notification distance; and activating a preset notification mode to alert the user if the remaining distance equals the location notification distance.

Other objects, advantages and novel features will become more apparent from the following detailed description of certain embodiments of the present disclosure when taken in conjunction with the accompanying drawings, in which:

### BRIEF DESCRIPTION OF THE DRAWINGS

FIG. 1 is a block diagram of an embodiment of a system for notification of location via an electronic device.

FIG. 2 is a flowchart of an embodiment of a method for notification of location via an electronic device.

### DETAILED DESCRIPTION OF CERTAIN INVENTIVE EMBODIMENTS

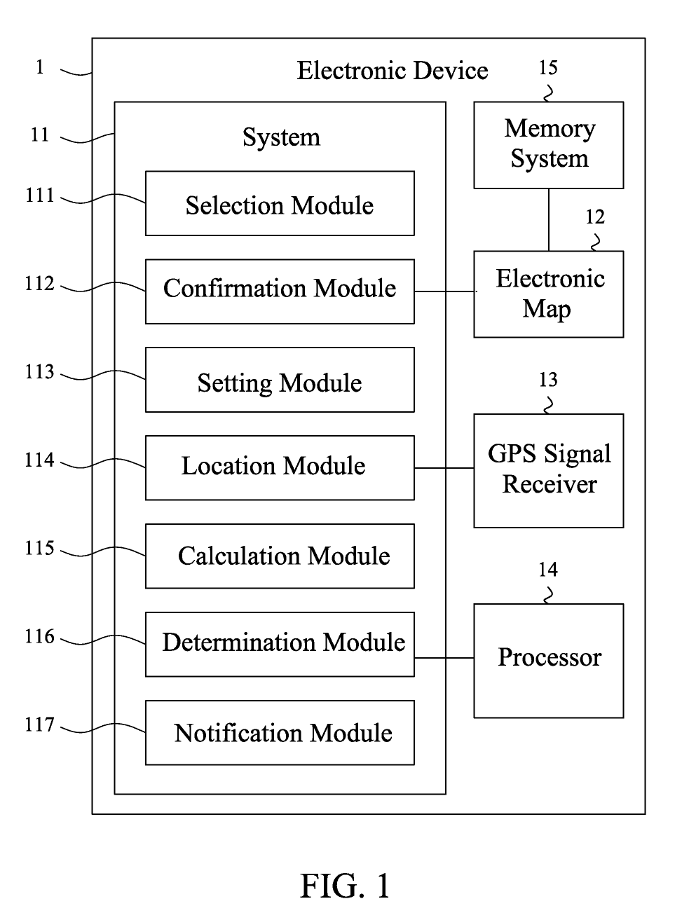

All of the processes described may be embodied in, and fully automated via, software code modules executed by one or more general purpose computers or processors as depicted in FIG. 1. The code modules may be stored in any type of computer-readable medium or other storage device. Some or all of the methods may alternatively be embodied in specialized computer hardware or communication apparatus.

FIG. 1 is a block diagram of an embodiment of a system 11 for notification of location via an electronic device. The system 11 may be embodied in an electronic device 1, which further includes an electronic map 12, a Global Positioning System (GPS) 13, a memory system 15 and a processor 14. In an exemplary embodiment, the GPS 13 may be a general GPS signal receiver relying on precise microwave signals from an array of Medium Earth Orbit (MEO) satellites to determine locations of the electronic device 1, while in other embodiments, the GPS 13 may include an Enhanced GPS (E-GPS) signal receiver to determine the locations of the electronic device 1 in poor GPS-reception areas, indoor environments and in zero GPS-signal conditions. Moreover, the electronic map 12 includes route information for public transportation systems such as bus, tram and railway train, and location information of stations and other locations on the public transportation systems. It may be understood that the electronic map 12 may be updated to add/edit/delete public transportation system information. The electronic map 12 is stored on the memory system 15. It may be understood that the memory system 15 may be a hard disk drive, a flash drive or any other kind of memory storage systems.

In an embodiment, the system 11 includes a selection module 111, a confirmation module 112, a setting module 113, a location module 114, a calculation module 115, a determination module 116, and a notification module 117. The modules 111, 112, 113, 114, 115, 116, 117 execute one or more operations for the arrival notification system 11. Additionally, the electronic device 1 may comprise one or more specialized or general purpose processors, such as the processor 14 for executing the modules 111, 112, 113, 114, 115, 116, 117.

The selection module 111 enables entry of a travel route and a desired location. Here, information regarding travel route and other information is stored in the electronic map 12. The selection module 111 makes corresponding selection of the travel route and the desired location according to user input and information provided by the electronic map 12. The selection module 111 then registers data of the user input, including the travel route and the desired location, from the information stored in the electronic map 12. For example, information stored in the electronic map 12 may include but is not limited to: a bus route 1, a bus route 2, a bus route 3, an underground train route 1, and an underground train route 2. Stations along the bus route 2 are A station, B station, C station, D station, E station, F station, G station, H station, I station, J station, and K station. The selection module may select the bus route 2 as the travel route and the I station as the desired location. It is to be noted that, while, here, locations stored in the system are stations, any location along the provided routes can be listed for selection while remaining within the scope of the disclosure.

The confirmation module 112 identifies the desired location from the electronic map 12 according to user input.

The setting module 113 sets a location notification distance and a notification mode. The notification distance may be used to notify a user of an approaching destination when the approaching destination is within a predetermined distance. Accordingly, the notification mode defines a method of notifying a user of the approaching destination. In the embodiment of the present disclosure, available location notification distances include, but are not limited to, notification when 100 meters(m), 500 m, and 1000 m remain before reaching the desired location. Notification modes include but are not limited to emitting audio, vibration, and/or a combination of the two of the system 11.

The location module 114 is configured for acquiring a current user location via the GPS signal receiver 13.

The calculation module 115 is configured for determining a distance between the current user location and the desired location according to the travel route.

The determination module 116 is configured for determining if a remaining distance between the current user location and the desired location equals a location notification distance. It may be understood that the remaining distance is a distance between a current user location (which may be constantly changing) and the desired location.

The notification module 117 activates the preset notification mode to alert the user if the remaining distance equals the location notification distance.

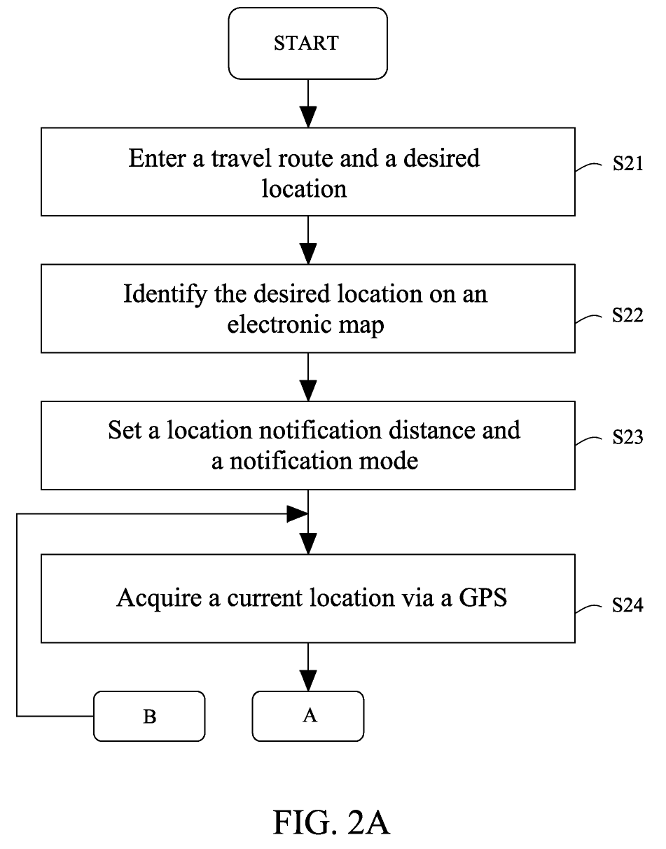

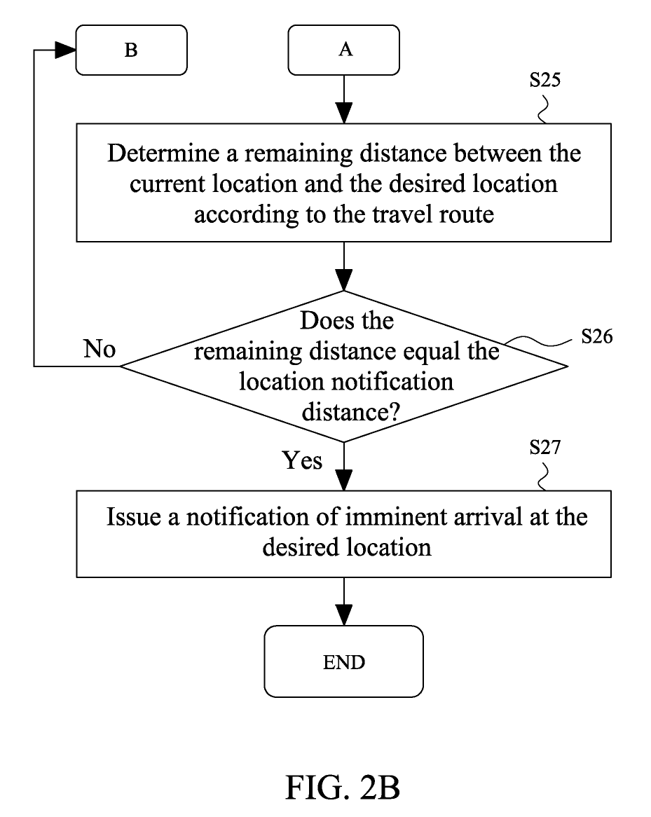

FIG. 2 is a flowchart of an embodiment of a method for notification of location via an electronic device. Depending on the embodiment, additional blocks may be added or deleted and the blocks may be executed in a different order than described. First, in block S21, a travel route and a desired location are input via the selection module 111. In the embodiment of the present disclosure, the information of the travel route and the information of locations along the travel route is stored in the electronic map 12. The selection module 111 registers data of the user input, including the travel route and the desired location, from the information stored in the electronic map 12.

In block S22, the confirmation module 112 confirms the desired location from the electronic map 12 according to the user input.

In block S23, the setting module 113 sets a location notification distance and a notification mode. As mentioned previously, the available location notification distances include, but are not limited to, notification when 100 m, 500 m, and 1000 m remain before reaching the location. Additionally, notification modes may include but are not limited to emitting audio, vibration, and/or a combination of one or more of the notification modes.

In block S24, the location module 114 acquires a current user location via the GPS signal receiver 13.

In block S25, the calculation module 115 calculates a distance between the current user location and the desired location according to the travel route.

In block S26, the determination module 116 is determines if a remaining distance between the current user location and the desired location equals the location notification distance.

In block S27, if the remaining distance equals the location notification distance, the notification module 117 activates the preset notification mode to alert the user, and the process is completed.

In block S26, if the remaining distance is not equal to the notification distance, block S24 is repeated to acquire the current user location.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. An electronic device comprising an electronic map and utilizing a Global Positioning System (GPS), the electronic device comprising:
a memory system configured for storing the electronic map;
a selection module configured for registering a travel route and a desired location using the electronic device, wherein the desired location is user-selected;
a confirmation module configured for identifying the desired location from the electronic map;
a setting module configured for setting a location notification distance and a notification mode;
a location module configured for acquiring a current user location using the GPS;
a calculation module configured for determining a distance between the current user location and the desired location according to the travel route;
a determination module configured for determining if a remaining distance equals the location notification distance, wherein the remaining distance is a distance between the current user location and the desired location according to the travel route;
a notification module configured for activating a preset notification mode to alert the user if the remaining distance equals the location notification distance; and
at least one processor executing the selection module, the confirmation module, the setting module, the location module, and the calculation module, the determination module, and the notification module to notify the user of location via the electronic device.

2. The system as claimed in claim 1, wherein information of travel routes and locations therealong is stored in the electronic map, and the selection module selects a travel route and a desired location from information provided thereby.

3. The system as claimed in claim 1, wherein notification modes include at least one of emitting audio, and vibration of the system.

4. The system as claimed in claim 1, wherein the GPS comprises a GPS signal receiver relying on microwave signals transmitted from an array of Medium Earth Orbit (MEO) satellites to determine location of the electronic device.

5. The system as claimed in claim 4, wherein the GPS further comprises an Enhanced GPS (E-GPS) signal receiver to determine the location of the electronic device.

6. A computer-implemented method for notification of location via an electronic device, the method comprising:
registering a travel route and a desired location using the electronic device, wherein the desired location is user-selected;
identifying a location of the desired location from an electronic map stored in a memory system of the electronic device;
setting a location notification distance and a notification mode;
acquiring a current user location via a Global Positioning System (GPS) of the electronic device;
determining a remaining distance between the current user location and the desired location according to the travel route, wherein the remaining distance is a distance between the current user location and the desired location according to the travel route;
determining if the remaining distance equals location notification distance; and
activating the preset notification mode to alert the user if the remaining distance equals the location notification distance.

7. The method as claimed in claim 6, further comprising repeating the location procedure, acquiring a current user location, if the remaining distance is not equal to the location notification distance.

8. The method as claimed in claim 6, wherein information of travel routes and locations therealong is stored in the electronic map.

9. The method as claimed in claim 6, wherein notification modes include at least one of emitting audio and vibration from the electronic device.

10. The method as claimed in claim 6, wherein the GPS comprises a GPS signal receiver relying on microwave signals transmitted from an array of Medium Earth Orbit (MEO) satellites to determine location of the electronic device.

11. The method as claimed in claim 10, wherein the GPS further comprises an Enhanced GPS (E-GPS) signal receiver to determine the location of the electronic device.

12. A computer-readable medium having stored thereon instructions that, when executed by a computer, cause the computer to perform a method for notification of location via an electronic device, the method comprising:
registering a travel route and a desired location using the electronic device, wherein the desired location is user-selected;
identifying a location of the desired location from an electronic map stored in a memory system of the electronic device;
setting a location notification distance and a notification mode;
acquiring a current user location via a Global positioning system (GPS) of the electronic device;
determining a remaining distance between the current user location and the desired location according to the travel route, wherein the remaining distance is a distance between the current user location and the desired location according to the travel route;
determining if the remaining distance equals location notification distance; and
activating the preset notification mode to alert the user if the remaining distance equals the location notification distance.

13. The computer-readable medium as claimed in claim 12, wherein the method further comprises repeating the location procedure, acquiring a current user location, if the remaining distance is not equal to the location notification distance.

14. The computer-readable medium as claimed in claim 12, wherein information of the travel route and locations therealong is stored in the electronic map.
